(19) United States
(12) Patent Application Publication
(10) Pub. No.: US 2025/0071484 A1
(43) Pub. Date: Feb. 27, 2025

(54) DUST CAP, DIAPHRAGM, AND ELECTROACOUSTIC TRANSDUCER

(71) Applicant: Panasonic Automotive Systems Co., Ltd., Kanagawa (JP)

(72) Inventors: Mitsukazu KUZE, Osaka (JP); Hiroyuki MORIMOTO, Osaka (JP)

(73) Assignee: Panasonic Automotive Systems Co., Ltd., Kanagawa (JP)

(21) Appl. No.: 18/797,007

(22) Filed: Aug. 7, 2024

(30) Foreign Application Priority Data
Aug. 22, 2023 (JP) 2023-134824

(51) Int. Cl. H04R 7/12; H04R 7/18; H04R 9/02; H04R 9/04; H04R 9/06

(52) U.S. Cl. CPC H04R 7/127; H04R 7/18; H04R 9/025; H04R 9/045; H04R 9/06; H04R 2307/021; H04R 2400/07; H04R 2400/11

(57) ABSTRACT

A dust cap is a dust cap to be provided at a central portion of a diaphragm included in an electroacoustic transducer. A first cross-sectional shape of the dust cap in a first plane that includes a predetermined reference axis extending in a vibration direction of the diaphragm and a second cross-sectional shape of the dust cap in a second plane that includes the reference axis and is orthogonal to the first plane are different.

### CROSS REFERENCE TO RELATED APPLICATION

The present application is based on and claims priority of Japanese Patent Application No. 2023-134824 filed on Aug. 22, 2023.

### FIELD

The present disclosure relates to a dust cap, a diaphragm to which the dust cap is provided, and an electroacoustic transducer including the diaphragm to which the dust cap is provided.

### BACKGROUND ART

Conventionally, for example, there are cases where a dome-type dust cap is disposed in a central portion of a cone-type diaphragm. With such a dust cap, which is a solid of revolution, the cross-sectional shape of the dust cap in a plane including a reference axis that passes through the center of the diaphragm and extends in the vibration direction of the diaphragm is uniform in the circumferential direction, which results in single resonance and a narrow reproduction band. In view of this, Patent Literature (PTL) 1 to 3 describe a dust cap having a cross-sectional shape in a plane including the reference axis that is not uniform in the circumferential direction. By adopting such a dust cape, single resonance can be suppressed.

### CITATION LIST

### Patent Literature

PTL 1: International Publication No. WO2017/183370
PTL 2: Japanese Unexamined Patent Application Publication No. H03-038998
PTL 3: Japanese Unexamined Patent Application Publication No. 2001-224095

### SUMMARY

However, the technique described in PTL 1 to 3 can be improved upon.

The present disclosure provides a dust cap, a diaphragm, and an electroacoustic transducer that are capable of improving upon the above related art.

A dust cap according to an aspect of the present disclosure is a dust cap to be provided at a central portion of a diaphragm included in an electroacoustic transducer, wherein a first cross-sectional shape of the dust cap in a first plane and a second cross-sectional shape of the dust cap in a second plane are different, the first plane including a reference axis that extends in a vibration direction of the diaphragm and is predetermined, the second plane including the reference axis and being orthogonal to the first plane.

A diaphragm according to an aspect of the present disclosure is a diaphragm included in an electroacoustic transducer and includes: a neck portion disposed around a reference axis that extends along a vibration direction of the diaphragm and is predetermined; and a first portion, a second portion, a third portion, and a fourth portion that are arranged around the reference axis on an outer side of the neck portion, the first portion, the second portion, the third portion, and the fourth portion having mutually different cross-sectional shapes in a plane including the reference axis, wherein the cross-sectional shape of the first portion is a circular arc having a first radius of curvature, the cross-sectional shape of the second portion is a circular arc having a second radius of curvature different from the first radius of curvature, the cross-sectional shape of the third portion is defined by a portion of an ellipse, a cross-sectional shape of the neck portion in any plane including the reference axis has a same curve, and a dust cap having a first cross-sectional shape in a first plane and a second cross-sectional shape in a second plane that are different is provided at a central portion of the diaphragm, the first plane including the reference axis, the second plane including the reference axis and being orthogonal to the first plane.

An electroacoustic transducer according to an aspect of the present disclosure includes: a dust cap having a first cross-sectional shape in a first plane and a second cross-sectional shape in a second plane that are different, the first plane including a reference axis that extends in a vibration direction of the diaphragm and is predetermined, the second plane including the reference axis and being orthogonal to the first plane; a diaphragm at the central portion of which the dust cap is provided; a magnetic circuit; a frame that holds the magnetic circuit and the diaphragm; and a voice coil that is connected to the diaphragm and disposed in a magnetic gap of the magnetic circuit.

A dust cap, a diaphragm, and an electroacoustic transducer according to an aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a plan view illustrating, from the front, a diaphragm with an edge attached.

FIG. 2 is a cross-sectional view of the diaphragm and the edge taken along line A-A in FIG. 1.

FIG. 3 is a cross-sectional view of the diaphragm and the edge taken along line B-B in FIG. 1.

FIG. 4 is a plan view illustrating a dust cap from the front.

FIG. 5 is a cross-sectional view of the dust cap taken along line C-C in FIG. 4.

FIG. 6 is a cross-sectional view of the dust cap taken along line D-D in FIG. 4.

FIG. 7 is a cross-sectional view of a loudspeaker device which is one example of an electroacoustic transducer that includes the diaphragm.

FIG. 8 is a graph illustrating the difference in sound pressure-frequency response between a loudspeaker device including a conventional diaphragm and a loudspeaker device including the diaphragm provided with the dust cap according to an embodiment of the present disclosure.

FIG. 9 is a cross-sectional view of a car which is one example of a mobile body to which a loudspeaker device including the diaphragm is attached.

FIG. 10 is a diagram illustrating a mini component system which is one example of an electronic device to which the loudspeaker device including the diaphragm is attached.

### DESCRIPTION OF EMBODIMENTS

Hereinafter, exemplary embodiments of a dust cap, a diaphragm, and an electroacoustic transducer according to the present disclosure will be described with reference to the drawings. It should be noted that each of the subsequent embodiments shows an example for describing the present disclosure, and thus is not intended to limit the present disclosure. For example, the shapes, structures, materials, structural components, the relative positional relationships and connections of the structural components, numerical values, formulas, steps, the processing order of the steps, and so on, shown in the following embodiments are mere examples, and details not described below may be included. Furthermore, although there are cases where geometric expressions, such as “parallel” and “orthogonal”, are used, these expressions are not mathematically precise indications and include substantially permissible error, deviation, and the like. Moreover, expressions, such as “simultaneous” and “identical (or the same)”, are considered to cover a substantially permissible range of meaning.

Additionally, the drawings are schematic illustrations that may include emphasis, omission, or adjustment of proportion as necessary for the purpose of describing the present disclosure, and thus the shapes, positional relationships, and proportions shown may be different from actuality. Furthermore, the X-axis, Y-axis, and Z-axis which may be shown in the drawings are arbitrarily set rectangular coordinates for describing the figures. In other words, the Z-axis is not limited to an axis in the vertical direction, and the X-axis and Y-axis are not limited to being axes inside a horizontal plane.

Furthermore, hereinafter, multiple inventions may be comprehensively described as a single embodiment. Moreover, part of the contents in the description below is described as an optional element related to the present disclosure.

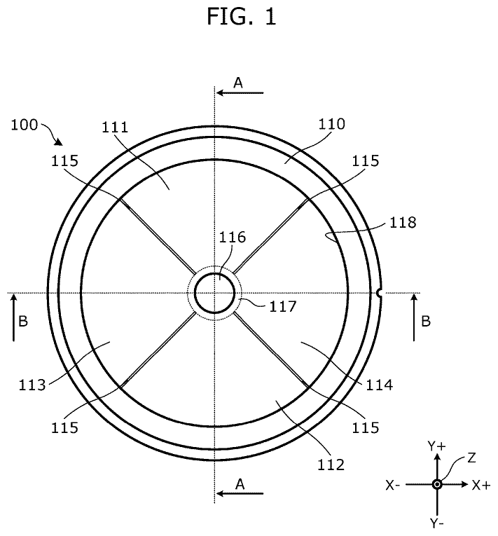

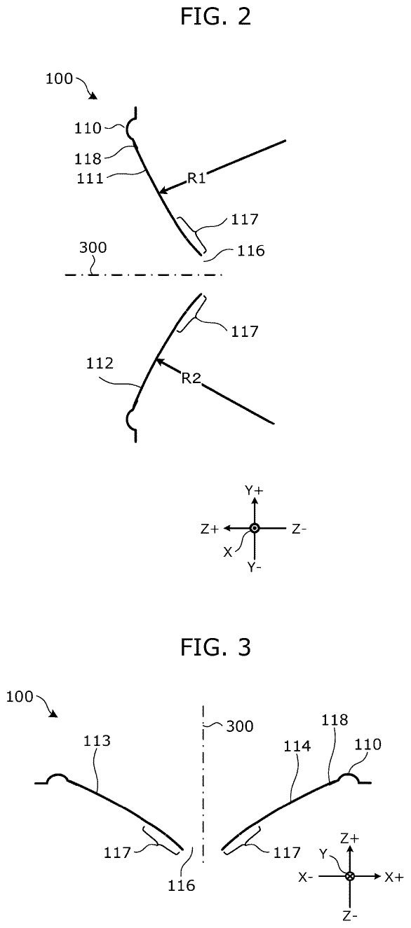

FIG. 1 is a plan view illustrating, from the front, diaphragm 100 with edge 110 attached. FIG. 2 is a cross-sectional view of diaphragm 100 and edge 110 taken along line A-A in FIG. 1. FIG. 3 is a cross-sectional view of diaphragm 100 and edge 110 taken along line B-B in FIG. 1.

Diaphragm 100 is a component that is included in an electroacoustic transducer such as a loudspeaker device or a microphone, and either vibrates to cause air to vibrate in order to generate sound or is made to vibrate based on the vibration of air. Diaphragm 100 includes at least first portion 111, second portion 112, third portion 113, and neck portion 117, and, in the present embodiment, also includes fourth portion 114.

First portion 111, second portion 112, third portion 113, and fourth portion 114 are arranged around a predetermined reference axis 300 (see FIG. 2 and FIG. 3) that extends in the vibration direction (the Z-axis direction in the figures). First portion 111, second portion 112, and third portion 113 are portions that have mutually different cross-sectional shapes in a plane that includes reference axis 300 (for example, the line A-A cross section and the line B-B cross section in FIG. 1). Third portion 113 and fourth portion 114 have the same cross-sectional shape in a plane that includes reference axis 300.

In the present embodiment, the shape of diaphragm 100 is circular in a plan view, that is, when viewed from the direction of reference axis 300, and the plan view shape of first portion 111, second portion 112, third portion 113, and fourth portion 114 are identical fan shapes. The plan view diameter of diaphragm 100 is approximately 100 mm. Furthermore, the plan view areas of first portion 111, second portion 112, third portion 113, and fourth portion 114 are the same. It should be noted that, since connection portion 115 (details to be described later) is provided at each of the boundaries between first portion 111, second portion 112, third portion 113, and fourth portion 114, the plan view shapes of first portion 111, second portion 112, third portion 113, and fourth portion 114 are not perfect fan shapes.

Third portion 113 and fourth portion 114 are disposed between first portion 111 and second portion 112. First portion 111 and second portion 112 are not adjacent (not side by side) to each other. Third portion 113 and fourth portion 114 are not adjacent to each other.

As illustrated in FIG. 2, the shape of first portion 111 in the cross section including reference axis 300 is a simple circular arc defined by first radius of curvature R1. The cross sectional shape of first portion 111 in any cross section including reference axis 300 is the same. In other words, first portion 111 is a portion of a solid of revolution around reference axis 300.

The shape of second portion 112 in a cross section including reference axis 300 is a simple circular arc defined by second radius of curvature R2. The cross sectional shape of second portion 112 in any cross section including reference axis 300 is the same. In other words, second portion 112 is a portion of a solid of revolution around reference axis 300. In the present embodiment, first radius of curvature R1>second radius of curvature R2. In the present embodiment, first radius of curvature R1>second radius of curvature R2×1.5, and more specifically, first radius of curvature R1=300 mm and second radius of curvature R2=200 mm.

As illustrated in FIG. 3, the cross-sectional shape of each of third portion 113 and fourth portion 114 is a portion of an ellipse. In the present embodiment, the cross-sectional shape of each of third portion 113 and fourth portion 114 is a one-fourth portion or yet a portion of a one-fourth portion obtained when an ellipse is cut along the major axis and the minor axis. The cross sectional shape of third portion 113 and fourth portion 114 in any cross section including reference axis 300 is the same. In other words, third portion 113 and fourth portion 114 are portions of a solid of revolution around reference axis 300.

Neck portion 117 is a portion of diaphragm 100 that is connected to the respective reference axis 300—ends of first portion 111, second portion 112, and third portion 113. In the present embodiment, neck portion 117 is connected to the respective reference axis 300—ends of fourth portion 114 and connection portions 115. Neck portion 117 is the portion to which dust cap 160 (see FIG. 7) is attached. The cross-sectional shapes of neck portion 117 in all planes including reference axis 300 are identical curves. Neck portion 117 is a solid of revolution having reference axis 300 as a central axis.

In the present embodiment, the cross-sectional shape of neck portion 117 in a plane including reference axis 300 is an circular arc, and neck portion 117 is smoothly connected to first portion 111, second portion 112, third portion 113, fourth portion 114, and connection portions 115. The radius of curvature of neck portion 117 is at most one-tenth the radius of curvature of the larger one of first radius of curvature R1 and second radius of curvature R2. In the present embodiment, the radius of curvature of neck portion 117 is at most one-tenth the radius of curvature of the smaller one of first radius of curvature R1 and second radius of curvature R2. Specifically, the radius of curvature of neck portion 117 is at most 20 mm.

Connection portions 115 are portions that connect the adjacent portions of diaphragm 100 that have different cross-sectional shapes, and make up portions of diaphragm 100. In the present embodiment, connection portions 115 smoothly connect the gap between first portion 111 and third portion 113, the gap between third portion 113 and second portion 112, the gap between second portion 112 and fourth portion 114, and the gap between fourth portion 114 and first portion 111.

In the present embodiment, the boundary lines of connecting portion 115 with first portion 111 and third portion 113, the boundary lines of connecting portion 115 with third portion 113 and second portion 112, the boundary lines of connecting portion 115 with second portion 112 and fourth portion 114, and the boundary lines of connecting portion 115 with fourth portion 114 and first portion 111 are disposed in parallel in a plan view.

Diaphragm 100 is realized by first portion 111, second portion 112, third portion 113, and fourth portion 114, connection portions 115, and neck portion 117 being formed integrally. In a plan view, through hole 116 that is connected to voice coil 131 (see FIG. 7) is provided at the center of neck component 117 of diaphragm 100. Through hole 116 is covered by dust cap 160 that is attached to neck portion 117.

Outer circumferential end portion 118 of diaphragm 100 in a plan view is integrally connected to second portion 112, third portion 113, fourth portion 114, and connections 115. Outer circumferential end portion 118 is a portion that is connected to edge 110. The face of outer circumferential end portion 118 that is connected to edge 110 is in the shape of a truncated cone. The thickness of the portion of outer circumferential end portion 118 corresponding to third portion 113 (and likewise to fourth portion 114) is greater than the thickness of the portion of outer circumferential end portion 118 corresponding to first portion 111. The difference in the thickness of outer circumferential end portion 118 with respect to each portion is based on a difference in thickness that increases in a direction moving away from edge 110. Making the face of outer circumferential end portion 118 that is connected to edge 110 into a truncated cone shape ensures a strong connection with edge 110, and the uneven shape of outer circumferential end portion 118 absorbs the differences in the cross-sectional shapes of the respective portions (i.e., the first to fourth portions).

The material of diaphragm 100 is not limited. For example, diaphragm 100 may be formed by papermaking using at least one of pulp or a synthetic fiber such as polyester fiber, and may be formed though injection molding of a resin into which a reinforcing material has been mixed. Furthermore, diaphragm 100 may be formed by press-forming a sheet or film-like material.

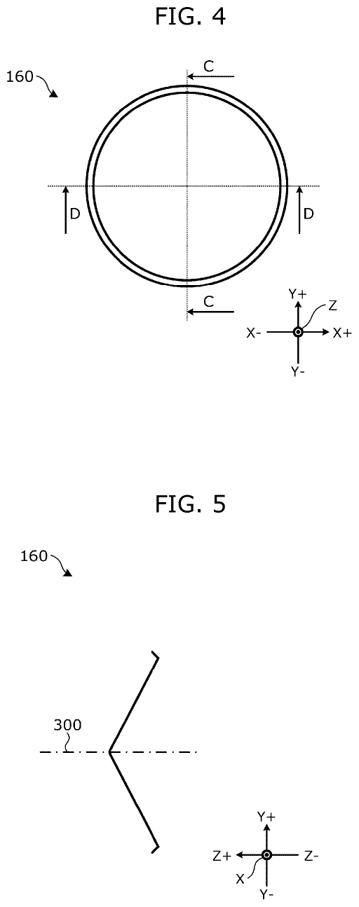

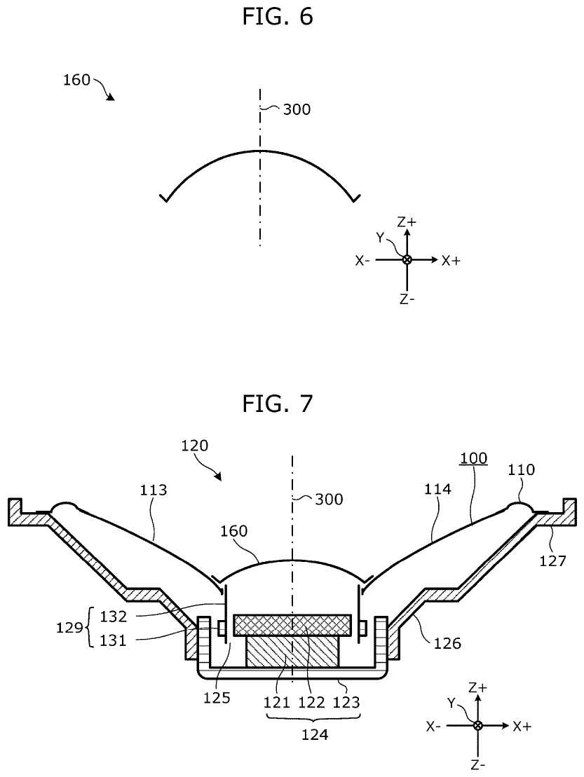

FIG. 4 is a plan view illustrating dust cap 160 from the front. FIG. 5 is a cross-sectional view of dust cap 160 taken along line C-C in FIG. 4. FIG. 6 is a cross-sectional view of dust cap 160 taken along line D-D in FIG. 4.

Dust cap 160 is a film-like component that is disposed in front (the Z+ side in the figures) of the central portion of diaphragm 100, and covers through hole 116 provided in diaphragm 100. In the present embodiment, the shape of dust cap 160 is circular in a plan view, that is, when viewed in the direction of reference axis 300, and bulges toward the front. The apex of dust cap 160 lies on reference axis 300, and dust cap 160 has a plane symmetrical shape in a plane including reference axis 300. By making dust cap 160 into a plane symmetrical shape, non-uniformity of directional-frequency response can be avoided.

Dust cap 160 is directly or indirectly connected to diaphragm 100. In the present embodiment, dust cap 160 is directly connected to the front-side face of neck portion 117 using an adhesive, or the like. It should be noted that dust cap 160 may be indirectly connected to diaphragm 100 by being connected to bobbin 132 (details to be described later), and so on, which is connected to diaphragm 100.

A first cross-sectional shape of dust cap 160 in a first plane including the predetermined reference axis 300 that extends in the vibration direction (the Z-axis direction in the figures) and a second cross-sectional shape of dust cap 160 in a second plane that includes reference axis 300 and is orthogonal to the first plane are different. In the present embodiment, the first cross section is the YZ plane in the figure, and the first cross-sectional shape defined by any two sides of a triangle. Furthermore, the first cross-sectional shape is defined by two oblique sides (the legs) of an isosceles triangle. The second cross section is the XZ plane in the figure, which is orthogonal to the first cross section, and the second cross-sectional shape is a curve. The curve is not limited and can be exemplified by a circular arc, a portion of an ellipse, a hyperbola, a parabola, and so on. The shape of dust cap 160 continuously changes in a circumferential direction about reference axis 300, from the first cross-sectional shape to the second cross-sectional shape. The cross-sectional shape of dust cap 160 in a plane (the XY plane in the figures) orthogonal to reference axis 300 is curved, and the portion connected to diaphragm 100 is circular.

The material of dust cap 160 is not limited. Furthermore, the material of dust cap 160 may be the same or different from the material of diaphragm 100. For example, dust cap 160 may be formed by papermaking (making a sheet) using at least one of a synthetic fiber such as polyester fiber or pulp, and may be formed though injection molding of a resin into which a reinforcing material has been mixed. Furthermore, dust cap 160 may be formed by press-forming a sheet or film-like material.

FIG. 7 is a cross-sectional view of loudspeaker device 120 which is one example of an electroacoustic transducer including diaphragm 100. As shown in FIG. 7, loudspeaker device 120 includes diaphragm 100, magnetic circuit 124, frame 126 that holds magnetic circuit 124 and diaphragm 100, and voice coil 131 that is connected to diaphragm 100 and disposed in the magnetic gap of magnetic circuit 124.

In the present embodiment, magnetic circuit 124 included in loudspeaker device 120 is an inner magnetism type magnetic circuit formed by sandwiching magnetized magnet 121 between upper plate 122 and yoke 123.

Yoke 123 of magnetic circuit 124 is connected to frame 126. Loop-shaped edge 110 that connects outer circumferential end portion 118 of diaphragm 100 and frame 126 is bonded to peripheral end portion 127 of frame 126. The central portion of diaphragm 100 is connected to one end of voice coil body 129. The other end of voice coil body 129 is disposed to fit in magnetic gap 125 of magnetic coil 124. It should be noted that, in this embodiment, voice coil body 129 is exemplified as including voice coil 131 and bobbin 132 around which voice coil 131 is wound. However, it is also acceptable to have voice coil body 129 that does not include bobbin 132.

Moreover, although loudspeaker device 120 including inner magnetism-type magnetic coil 124 is described, the present disclosure is not limited to this configuration, and diaphragm 100 may be applied to loudspeaker device 120 including an outer magnetism-type magnetic circuit.

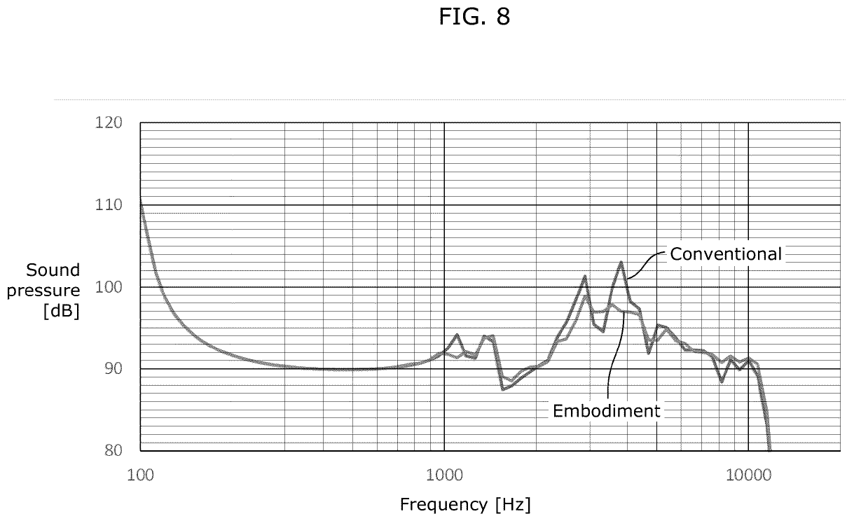

FIG. 8 is a graph illustrating the difference in sound pressure-frequency response between a loudspeaker device including a conventionally-shaped diaphragm and loudspeaker device 120 including diaphragm 100 provided with dust cap 160 according to the present embodiment. As illustrated in FIG. 8, in the sound pressure-frequency response of a speaker device including a conventional diaphragm, a significant peak-dip is present in the vicinity of 3 kHz and 4 kHz. In contrast, with speaker device 120 including diaphragm 100 according to the present embodiment, resonance scattering is effectively realized thereby suppressing peak-dips, and, in particular, flat acoustic characteristics can be obtained in the vicinity of 3 kHz and 4 kHz.

With speaker device 120 according to the present embodiment, it is possible to effectively scatter the resonance of diaphragm 100, and thus obtain a loudspeaker having flat sound pressure-frequency response in the intermediate to high range. Furthermore, the loudspeaker high-range threshold frequency can be expanded, high fidelity reproduction becomes possible, and sound quality with high clarity can be realized.

It should be noted that the present disclosure is not limited to the above-described embodiments. For example, other embodiments that can be realized by arbitrarily combining structural elements or removing some structural elements described in the present Specification may be embodiments of the present disclosure. Furthermore, variations obtainable through various modifications to the above-described embodiments that can be conceived by a person of ordinary skill in the art without departing from the essence of the present disclosure, that is, the meaning of the recitations in the Claims are included in the present disclosure.

For example, although dust cap 160 having a first cross-sectional shape defined by two straight lines and a second cross-sectional shape defined by a curve has been described, the first cross-sectional shape and the second cross-sectional shape may be defined by straight lines having different gradients. Furthermore, the first cross-sectional shape and the second cross-sectional shape may be defined by curves having different shapes.

Furthermore, although a case in which the cross-sectional shape of third portion 113 and the cross-sectional shape of fourth portion 114 of diaphragm 100 are the same has been described as an embodiment, the cross-sectional shape of third portion 113 and the cross-sectional shape of fourth portion 114 may be different. Specifically, the shape of fourth portion 114 need not be a portion of an ellipse, and an arbitrary shape can be adopted.

Furthermore, the loop-shaped edge 110 interposed between diaphragm 100 and frame 126 may include a diaphragm connection portion that follows the shape of the outer circumferential end portion of diaphragm 100, that is, a shape that follows the differences in the cross-sectional shapes of the respective portions (i.e., the first to fourth portions) of diaphragm 100.

Furthermore, although the cross-sectional shape of neck portion 117 is described as being a circular arc, the cross-sectional shape of neck portion 117 may be any curve such as a portion of an ellipse, a portion of a hyperbola, and so on.

Furthermore, although a case where, in a top view, diaphragm 100 is divided, at 90 degree intervals on the plane, into four equal portions, the respective portions need not be equal portions. Furthermore, diaphragm 100 may have three portions having different cross-sectional shapes or five or more portions having different cross-sectional shapes.

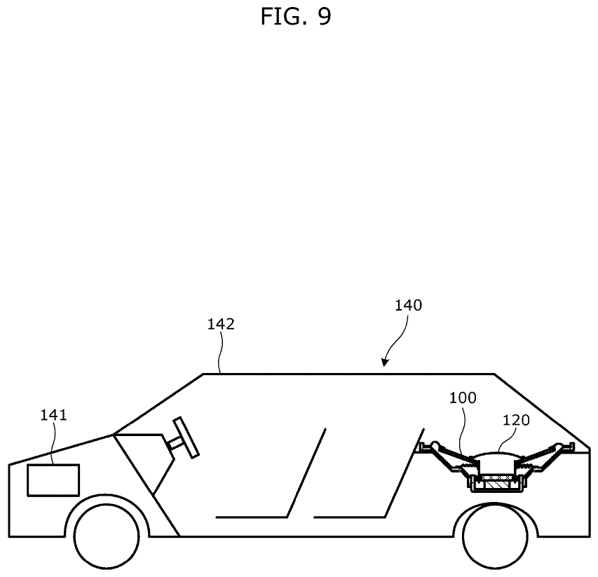

Furthermore, the electroacoustic transducer including diaphragm 100 to which dust cap 160 is provided may be included in a mobile body. FIG. 9 is a cross-sectional view of car 140 which is an example of a mobile body to which loudspeaker device 120 including diaphragm 100 is attached. Car 140 includes loudspeaker devices 120, each of which includes diaphragm 100, in the front panel, pillars, doors, and so on, aside from in a rear tray. Loudspeaker devices 120 are used as part of a car navigation system and/or car audio system. Car 140 includes driving means 141, and loudspeaker devices 120 travel together with car body 142 that functions as a casing that houses loudspeaker devices 120.

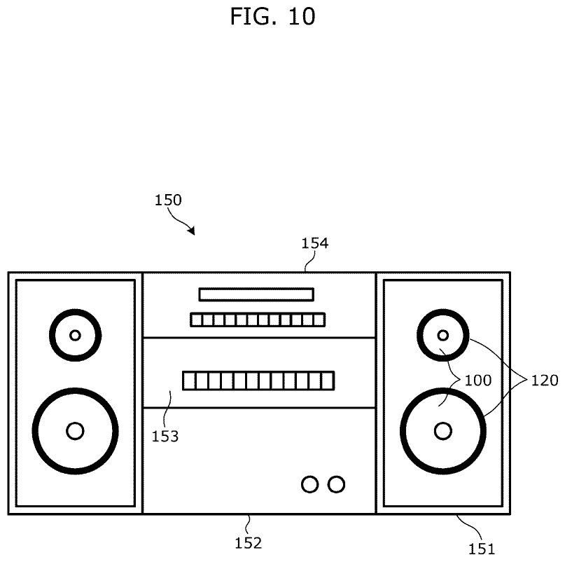

Furthermore, loudspeaker device 120 that includes diaphragm 100 to which dust cap 160 is provided may be included in an electronic device as illustrated in FIG. 10. FIG. 10 is a diagram illustrating another usage example of loudspeaker device 120 including diaphragm 100. Audio mini component system 150 will be described as one example of an electronic device that includes loudspeaker device 120 including diaphragm 100.

In mini component system 150, loudspeakers 120 are built into each of two enclosures 151. Furthermore, mini component system 150 includes amplifier 152 that includes an amplifying circuit for an electrical signal that is inputted to loudspeaker devices 120, tuner 153 that outputs a source signal to be inputted to amplifier 152, and compact disc (CD) player 154. In mini component system 150 which is an audio mini component system, a music signal inputted from tuner 153 or CD player 154 is amplified by amplifier 152, and sound is discharged by loudspeaker devices 120 based on the amplified signal. It should be noted that, aside from mini component system 150, examples of an electronic device include a car audio system or a portable audio device, video devices such as a liquid-crystal television, an organic electroluminescence (EL) display television, or the like, an information communication device such as a mobile phone, or the like, and computer-related devices, and so on.

Dust cap 160 according to a first aspect of the present disclosure is a dust cap to be provided at a central portion of diaphragm 100 included in an electroacoustic transducer, in which a first cross-sectional shape of dust cap 160 in a first plane and a second cross-sectional shape of dust cap 160 in a second plane are different. Here, the first plane includes predetermined reference axis 300 that extends in a vibration direction of diaphragm 100, and the second plane includes reference axis 300 and is orthogonal to the first plane.

Dust cap 160 according to the first aspect enables scattering of resonance frequency and expansion of the high-frequency range reproduction band.

Dust cap 160 according to a second aspect of the present disclosure is dust cap 160 according to the first aspect in which the first cross-sectional shape is defined by any two sides of a triangle.

Dust cap 160 according to a third aspect of the present disclosure is dust cap 160 according to the second aspect in which the first cross-sectional shape is defined by two oblique sides of an isosceles triangle.

The second aspect and the third aspect facilitate the manufacturing of dust cap 160.

Dust cap 160 according to a fourth aspect of the present disclosure is dust cap 160 according to any one of the first to third aspects in which a cross-sectional shape of dust cap 160 changes continuously from the first cross-sectional shape to the second cross-sectional shape.

Dust cap 160 according to a fifth aspect of the present disclosure is dust cap 160 according to any one of the first to fourth aspects in which a cross-sectional shape of dust cap 160 in a plane that is orthogonal to the reference axis is curved.

The fourth aspect and the fifth aspect can prevent a portion that is abnormal in shape from appearing dust cap 160, and thus can improve sound quality.

Dust cap 160 according to a sixth aspect of the present disclosure is dust cap 160 according to any one of the first to fifth aspects in which dust cap 160 is formed by papermaking using a material including at least one of pulp or a synthetic fiber.

Dust cap 160 according to a seventh aspect of the present disclosure is dust cap 160 according to any one of the first to fifth aspects in which dust cap 160 is formed by injection-molding of a resin.

Dust cap 160 according to an eighth aspect of the present disclosure is dust cap 160 according to any one of the first to fifth aspects in which dust cap 160 is formed by press-forming a material that is in a form of a sheet or film.

Diaphragm 100 according to a ninth aspect of the present disclosure is a diaphragm included in an electro acoustic transducer and includes: neck portion 117 disposed around predetermined reference axis 300 that extends along a vibration direction of diaphragm 100; and first portion 111, second portion 112, third portion 113, and fourth portion 114 that are arranged around reference axis 300 on an outer side of neck portion 117, and have mutually different cross-sectional shapes in a plane including reference axis 300. Here, the cross-sectional shape of first portion 111 is a circular arc having a first radius of curvature, the cross-sectional shape of second portion 112 is a circular arc having a second radius of curvature different from the first radius of curvature, the cross-sectional shape of third portion 113 is defined by a portion of an ellipse, and a cross-sectional shape of neck portion 117 in any plane including the reference axis has a same curve. Furthermore, dust cap 160 according to any one of the first to eighth aspects is provided at a central portion of diaphragm 100.

An electroacoustic transducer according to a tenth aspect of the present disclosure includes: dust cap 160 according to any one of the first to eighth aspects; diaphragm 100; magnetic circuit 124; frame 126 that holds magnetic circuit 124 and diaphragm 100; and voice coil 131 that is connected to diaphragm 100 and disposed in a magnetic gap of magnetic circuit 124.

The electroacoustic transducer according to an eleventh aspect of the present disclosure is the electroacoustic transducer according to the tenth aspect in which diaphragm 100 includes: first portion 111, second portion 112, third portion 113, and fourth portion 114 that are arranged around predetermined reference axis 300 extending in a vibration direction of diaphragm 100, and have mutually different cross-sectional shapes in a plane including reference axis 300. Here, the cross-sectional shape of first portion 111 is a circular arc having a first radius of curvature, the cross-sectional shape of second portion 112 is a circular arc having a second radius of curvature different from the first radius of curvature, and the cross-sectional shape of third portion 113 is defined by a portion of an ellipse.

Further Information about Technical Background to this Application

The disclosure of the following patent application including specification, drawings, and claims is incorporated herein by reference in its entirety: Japanese Patent Application No. 2023-134824 filed on Aug. 22, 2023.

### INDUSTRIAL APPLICABILITY

A dust cap, a diaphragm, and an electroacoustic transducer according to the present disclosure can be applied to an electronic device such as an audiovisual device or an information communication device, a mobile body such as a car, and so on.

1. A dust cap to be provided at a central portion of a diaphragm included in an electroacoustic transducer, wherein
a first cross-sectional shape of the dust cap in a first plane and a second cross-sectional shape of the dust cap in a second plane are different, the first plane including a reference axis that extends in a vibration direction of the diaphragm and is predetermined, the second plane including the reference axis and being orthogonal to the first plane.

2. The dust cap according to claim 1, wherein
the first cross-sectional shape is defined by any two sides of a triangle.

3. The dust cap according to claim 2, wherein
the first cross-sectional shape is defined by two oblique sides of an isosceles triangle.

4. The dust cap according to claim 1, wherein
a cross-sectional shape of the dust cap changes continuously from the first cross-sectional shape to the second cross-sectional shape.

5. The dust cap according to claim 1, wherein
a cross-sectional shape of the dust cap in a plane that is orthogonal to the reference axis is curved.

6. The dust cap according to claim 1, wherein
the dust cap is formed by papermaking using a material including at least one of pulp or a synthetic fiber.

7. The dust cap according to claim 1, wherein
the dust cap is formed by injection-molding of a resin.

8. The dust cap according to claim 1, wherein
the dust cap is formed by press-forming a material that is in a form of a sheet or film.

9. A diaphragm included in an electroacoustic transducer, the diaphragm comprising:
a neck portion disposed around a reference axis that extends along a vibration direction of the diaphragm and is predetermined; and
a first portion, a second portion, a third portion, and a fourth portion that are arranged around the reference axis on an outer side of the neck portion, the first portion, the second portion, the third portion, and the fourth portion having mutually different cross-sectional shapes in a plane including the reference axis, wherein
the cross-sectional shape of the first portion is a circular arc having a first radius of curvature,
the cross-sectional shape of the second portion is a circular arc having a second radius of curvature different from the first radius of curvature,
the cross-sectional shape of the third portion is defined by a portion of an ellipse,
a cross-sectional shape of the neck portion in any plane including the reference axis has a same curve, and
the dust cap according to claim 1 is provided at a central portion of the diaphragm.

10. An electroacoustic transducer comprising:
the dust cap according to claim 1;
a diaphragm;
a magnetic circuit;
a frame that holds the magnetic circuit and the diaphragm; and
a voice coil that is connected to the diaphragm and disposed in a magnetic gap of the magnetic circuit.

11. The electroacoustic transducer according to claim 10, wherein
the diaphragm includes:
a first portion, a second portion, a third portion, and a fourth portion that are arranged around a reference axis that extends in a vibration direction of the diaphragm and is predetermined, the first portion, the second portion, the third portion, and the fourth portion having mutually different cross-sectional shapes in a plane including the reference axis,
the cross-sectional shape of the first portion is a circular arc having a first radius of curvature,
the cross-sectional shape of the second portion is a circular arc having a second radius of curvature different from the first radius of curvature,
the cross-sectional shape of the third portion is defined by a portion of an ellipse.
